(19) United States
(12) Patent Application Publication
(10) Pub. No.: US 2004/0199514 A1
(43) Pub. Date: Oct. 7, 2004

(54) Techniques for facilitating item sharing

(76) Inventors: Ira Rosenblatt, Great Falls, VA (US); Justin Uberti, Sterling, VA (US)

Correspondence Address: FISH & RICHARDSON P.C., 1425 K STREET, N.W., 11TH FLOOR, WASHINGTON, DC, 20005-3500, US

(21) Appl. No.: 10/404,108

(22) Filed: Apr. 2, 2003

(51) Int. Cl. G06F 17/30

(52) U.S. Cl. 707/10

(57) ABSTRACT

A share window is provided to enable a first user of a first communication program executing on a first client system to share files or folders across a network with a second user of a second communication program executing on a second client system. The first user can use a share window to designate files or folders for sharing without changing locations of the files or folders. When a file or folder is designated for sharing using the share window, the file or folder is added to a list of shared files or folders. The shared files or folders are accessible using the second communication program regardless of whether the users of the first and second communication programs are actively communicating using the communications programs.

### TECHNICAL FIELD

This description relates to electronic communications.

### BACKGROUND

With the advent of the Internet and a decline in computer prices, many people are communicating with one another through computers interconnected by networks. A number of different communications programs have been developed to facilitate such communications between computer users. Instant messaging (IM) programs are one type of communications programs that have developed. IM programs generally provide the ability to easily see whether another user is connected to the network and, if so, to communicate and interact with the other user in real-time. Many IM programs support file sharing. File sharing generally is the public or private sharing of computer files across a network. To support file sharing, IM programs typically allow a first user to designate a share folder on a first computer connected to a network using a copy of the IM program executing on the first computer. Any files contained in the share folder are accessible across the network by a copy of a communications-enabled IM program executing on a second computer.

### SUMMARY

In one general aspect, a share window is provided to assist a first user of a first communications program executing on a first client system in sharing files or folders across a network with a second user of a second communications program executing on a second client system. The first user can use the share window to designate files or folders for sharing without changing the location of the files or folders. When a file or folder is designated for sharing, the file or folder is added to a list of shared files or folders. The shared files or folders are accessible using the second communications program regardless of whether the users of the first and second communications programs are actively communicating using the communications programs.

Implementations may include one or more of the following features. For example, designating files or folders for sharing may include dragging and dropping files or folders into the share window. Representations of shared files or folders may be added to the share window to indicate which files or folder are shared. When representations are provided, drag and drop removal of a file or folder from the sharewindow may be supported by allowing the representations to be dragged and dropped out of the share window. In response to a representation being dragged and dropped out of the share window, the corresponding file or folder is removed from the list of shared files or folders.

An add button may be provided as part of the share window. When the first user selects the add button, an open dialog box is invoked to allow the first user to select a file or folder to be added to the list of shared files or folders.

A remove button may be provided as part of the share window. When the first user selects the remove button and selects a representation of a file or folder, the file or folder that corresponds to the selected representation is removed from the list of shared files or folders.

A reveal button may be provided as part of the share window. When the first user selects the reveal button and selects a representation of a file or folder, a file system browser window is invoked to show the location of the file or folder that corresponds to the selected representation.

Implementations of the described techniques may include hardware, a method or process, or computer software on a computer-accessible medium.

The details of one or more implementations are set forth in the accompanying drawings and the description below. Other features will be apparent from the description and drawings, and from the claims.

### DESCRIPTION OF DRAWINGS

FIG. 1 is a block diagram of a networked computing environment 100 that supports communications and file sharing between instant messaging program users.

FIG. 2 is a screen display of an interface presented to a user of a client system when an IM program is executing.

FIGS. 3A-3D are screen displays of interfaces that allow an IM program user to access a contact's shared files or folders.

FIG. 4 is a flow chart of a method for facilitating a user of an IM program executing on a first client system in sharing files or folders across a network with a user of an IM program executing on a second client system.

FIGS. 5A-5J are screen displays showing an exemplary share window and various operations using the share window.

Like reference symbols in the various drawings indicate like elements.

### DETAILED DESCRIPTION

In general, a user interface facilitates file sharing across a network between a first user of a communications program executing on a first client system and a second user of a communications program executing on a second client system. The user interface includes a share window with which the first user can designate files or folders for sharing without changing the location of the files or folders. Once designated for sharing, files or folders are accessible regardless of whether the users are actively communicating using the communications programs.

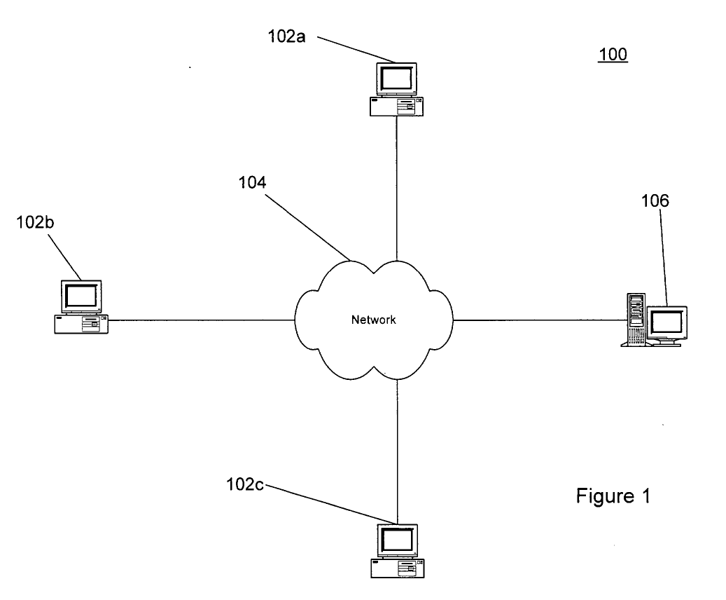

FIG. 1 illustrates an exemplary networked computing environment 100 that supports communications and file sharing between users of instant messaging programs. Users are distributed geographically and communicate using client systems 102a-102c. A network 104 interconnects client systems 102a-102c, which are connected to network 104 through various communication mediums, such as a modem connected to a telephone line (using, for example, serial line internet protocol (SLIP) or point-to-point protocol (PPP)) or a direct internetwork connection (using, for example, transmission control protocol/internet protocol (TCP/IP)).

Each of the client systems 102a-102c may be implemented using, for example, a general-purpose computer capable of responding to and executing instructions in a defined manner, a personal computer, a special-purpose computer, a workstation, a server, a device, a component, or other equipment or some combination thereof capable of responding to and executing instructions. Client systems 102a-102c may receive instructions from, for example, a software application, a program, a piece of code, a device, a computer, a computer system, or a combination thereof, which independently or collectively direct operations, as described herein. These instructions may take the form of one or more communications programs that facilitate communications between the users of client systems 102a-102c. For instance, such communications programs may include electronic mail (e-mail) programs, IM programs, file transfer protocol (FTP) programs, or voice-over-IP (VoIP) programs. The instructions may be embodied permanently or temporarily in any type of machine, component, equipment, storage medium, or propagated signal that is capable of being delivered to the client systems 102a-102c.

Client systems 102a-102c include a communications interface (not shown) used by the communications programs to send communications through network 104. The communications may include e-mail, audio data, video data, general binary data, or text data (e.g., data encoded in American Standard Code for Information Interchange (ASCII) format).

The network 104 typically includes a series of portals interconnected through a coherent system. Examples of the network 104 include the Internet, Wide Area Networks (WANs), Local Area Networks (LANs), analog or digital wired and wireless telephone networks (e.g., a Public Switched Telephone Network (PSTN)), an Integrated Services Digital Network (ISDN), or a Digital Subscriber Line (xDSL)), or any other wired or wireless network. The network 104 may include multiple networks or subnetworks, each of which may include, for example, a wired or wireless data pathway.

A host server 106 also may be connected to network 104 and may be used to faciltate some direct or indirect communications between the client systems 102a-102c. As with the client systems 102a-102c, host server 106 may be implemented using, for example, a general-purpose computer capable of responding to and executing instructions in a defined manner, a personal computer, a special-purpose computer, a workstation, a server, a device, a component, or other equipment or some combination thereof capable of responding to and executing instructions. Host server 106 may receive instructions from, for example, a software application, a program, a piece of code, a device, a computer, a computer system, or a combination thereof, which independently or collectively direct operations, as described herein. These instructions may take the form of one or more communications programs. Such communications programs may include, for example, e-mail programs, IM programs, FTP programs, and VoIP programs. The instructions may be embodied permanently or temporarily in any type of machine, component, equipment, storage medium, or propagated signal that is capable of being delivered to the host server 106.

Further, host server 106 includes a communications interface (not shown) used by the communications programs to send communications through network 104. The communications may include e-mail, audio data, video data, general binary data, or text data.

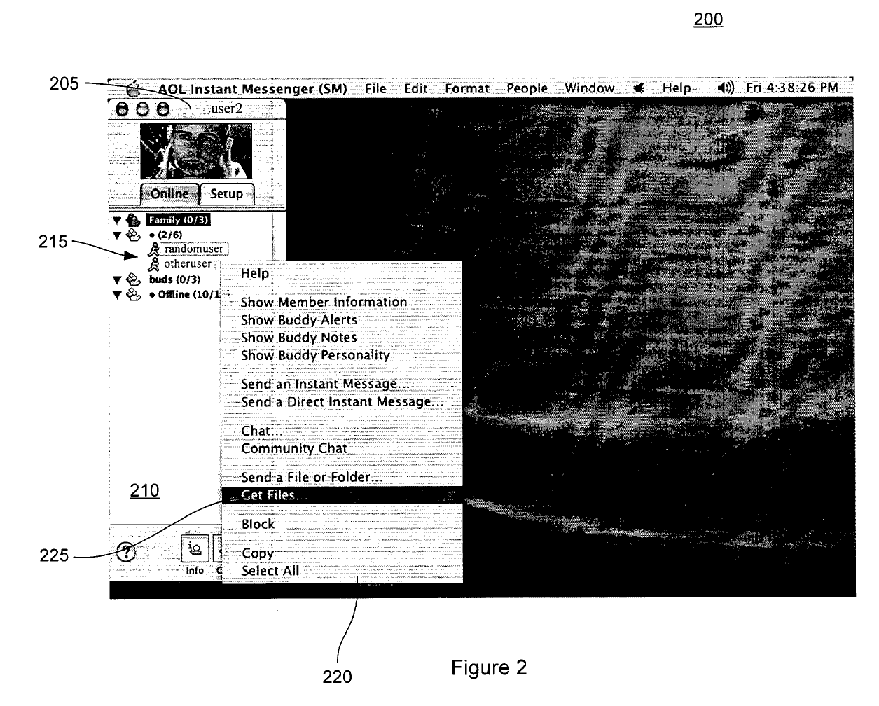

FIG. 2 illustrates an exemplary interface presented to a user of one of the client systems, such as client system 102a, when an instant messaging (IM) program is executing. The IM program allows a user to communicate in real time with other users in a variety of ways. For example, the IM program may allow the user to send text as an instant message, to transfer files, and to communicate by voice. Examples of IM programs include those provided by AIM (America Online Instant Messenger), AOL (America Online) Instant Messaging, Yahoo Messenger, MSN Messenger, and ICQ.

As shown, a desktop 200 presents a user interface 205 of the IM program. User interface 205 has a text box 210 that displays representations 215 of the program user's contacts or buddies (both terms are used interchangeably herein), which are other users of an IM program executing on another client system, such as client system 102b. For instance, in the exemplary interface shown, there are representations for two contacts, “randomuser” and “otheruser.” The representations 215 may provide status information to the program user about each contact, such as whether the contact is online, how long the contact has been online, whether the contact is away, or whether the contact is using a mobile device.

The list of contacts displayed in text box 210 of user interface 205 typically is referred to as the contact list or buddy list. The IM program user may add or remove contacts from the contact list. In the example shown, the representations 215 are icons showing the screen names of the contacts.

The IM programs may use an instant messaging server to assist in communications between users of the IM programs. The IM server may be implemented, for example, using host server 106. The host server 106 may support IM services irrespective of a program user's network or Internet access. Thus, for example, host server 106 may allow users to send and receive IMs, regardless of whether they have access to any particular Internet service provider (ISP). The host server 106 also may support associated services, such as administrative matters, advertising, directory services, chat, and interest groups related to IM.

To facilitate the transfer of data, the host server 106 employs one or more standard or proprietary IM protocols. The one or more protocols may enable the host server 106 to facilitate the establishment of a peer-to-peer communication session between the IM client programs, or assist IM communications by directly routing communications between the IM client programs.

To engage in IM communications when using a host server 106, an IM program running on one of client systems 102a-102d establishes a connection with the host server 106 and logs onto the host server 106. Once the IM program is logged on, a user can use the IM program to view whether particular contacts are online, exchange IMs with particular contacts, participate in group chat rooms, or trade files such as pictures, invitations or documents. The user also may be able to find other users with similar interests, get customized information such as news and stock quotes, and search the World Wide Web.

When a contact is online, the user can communicate or interact with the contact in a number of ways. For instance, the user can send an IM to the contact (typically in the form of text). Sending a message opens up a window in which messages can be typed and viewed as they are communicated back-and-forth between the user and the contact. Similarly, the user also can send a file or other content to the contact.

When a contact is online, the user also can use the IM program to access files or folders on the contact's client system that the contact has designated as being available for sharing. In environments where security is a concern, such as the Internet, it is useful to share files or folders without jeopardizing the security of other aspects of a client system. Sharing through a communications program such as an IM program may provide an extra layer of security that helps to prevent the other aspects of a system from being exposed and jeopardized.

The shared files or folders are accessible regardless of whether the user is actively interacting or communicating with the contact at the time that the user accesses the file. That is, the user and the contact do not have to be engaged in an IM session or other communication (e.g., VoIP session, videoconference session, or chat session) for the files to be accessible to the program user through the IM program. Allowing access even when the user and the contact are not actively interacting or communicating reduces the effort involved in sharing files by allowing the contact to share a file or folder when online, even though the contact is away from his or her client system, does not want to be involved in communications at that time, or does not want to be involved in communications with the user accessing the file or folder at the time the file or folder is accessed.

The user may initiate the access, for example, by using a context menu 220 that is invoked when the user selects a contact's representation by “right-clicking” on that representation. A user may “right-click” on a representation by using an input device like a mouse with a left and right button to point a cursor at the icon and by pressing the right button of the mouse. The context menu 220 has a number of options for actions that can be performed relating to the selected contact.

One of the options is a “Get Files” option 225. When the user selects the Get Files option 225, the IM program executing on the user's client system communicates with the IM program on the contact's client system to obtain a list of the available shared files or folders (if any are shared). Access permissions also may be implemented, in which case the IM program executing on the user's client system communicates with the IM program on the contact's client system to determine, as a condition of obtaining the list, whether the user is permitted to access the shared files or folders. The IM programs may communicate directly with one another, or they may communicate through a host server.

In the event that no items are available for sharing, a host server may alert the IM program on the user's client system that no items are available for sharing, and the user's IM program may disable the Get Files option within the context menu 220. In response, the disabled status of the Get Files option may be indicated visually (e.g., by being greyed out or removed) or otherwise indicated.

In other implementations, an alert may not be received from a host server or the Get Files option may remain available even when no items are available for sharing. In this case, a message indicating that no items to be shared are available may be sent from the contact's IM program to the user's IM program in response to the communication resulting from the user selecting the Get Files option. The user's IM program then may alert the user that no items are available for sharing.

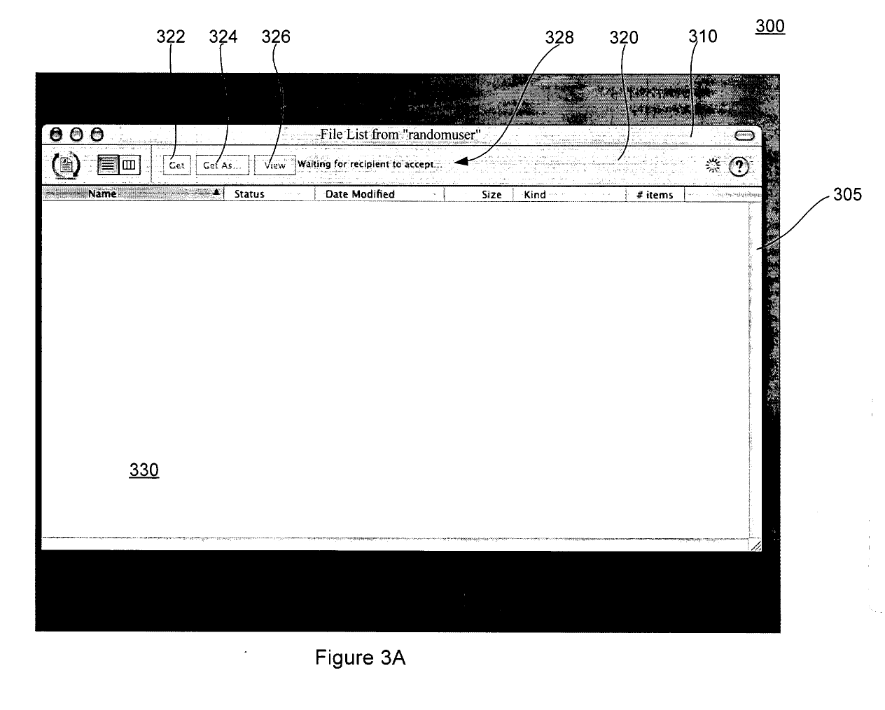

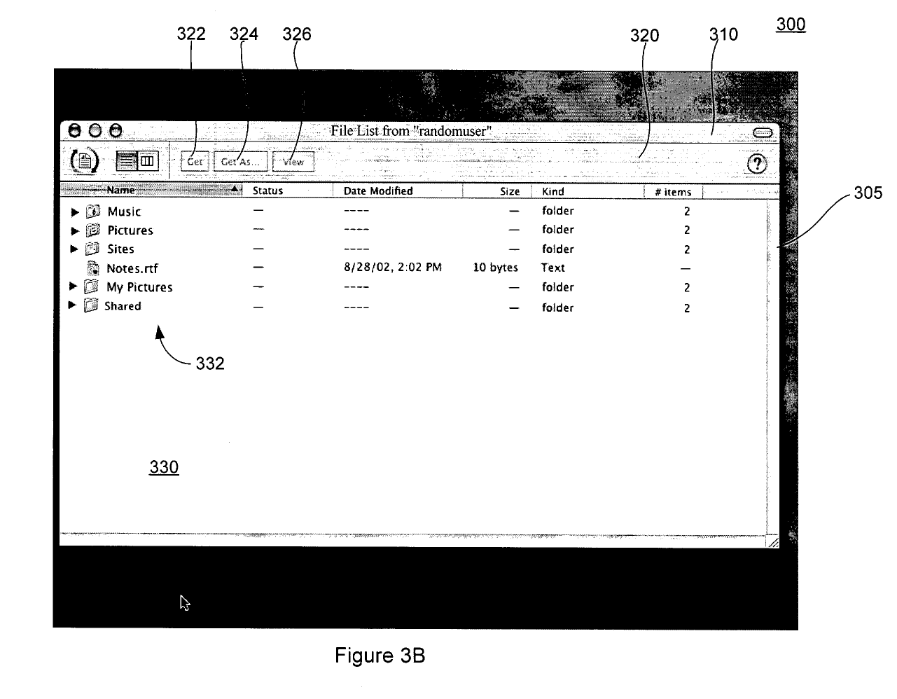

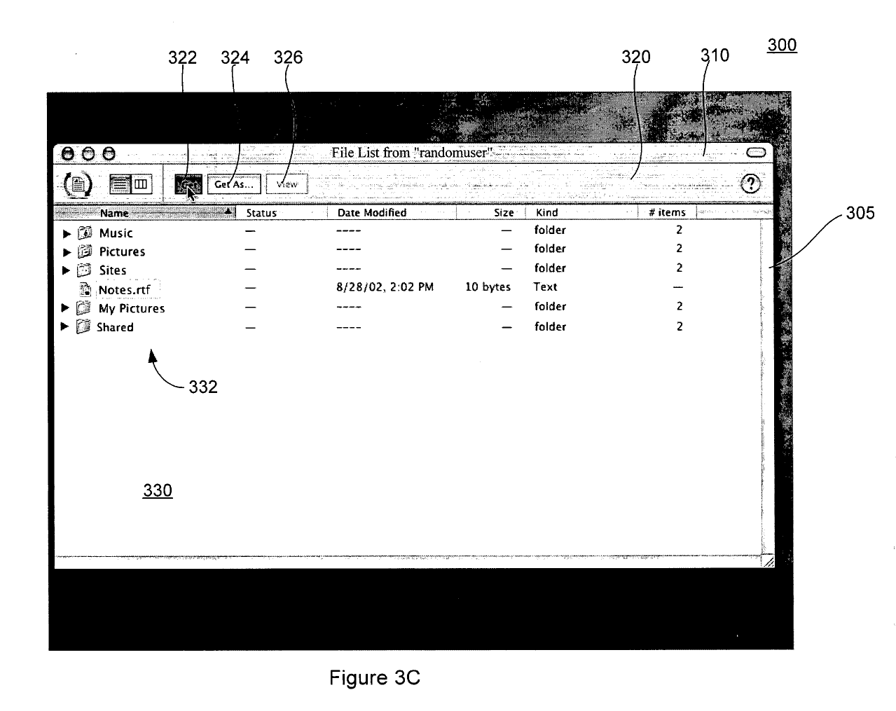

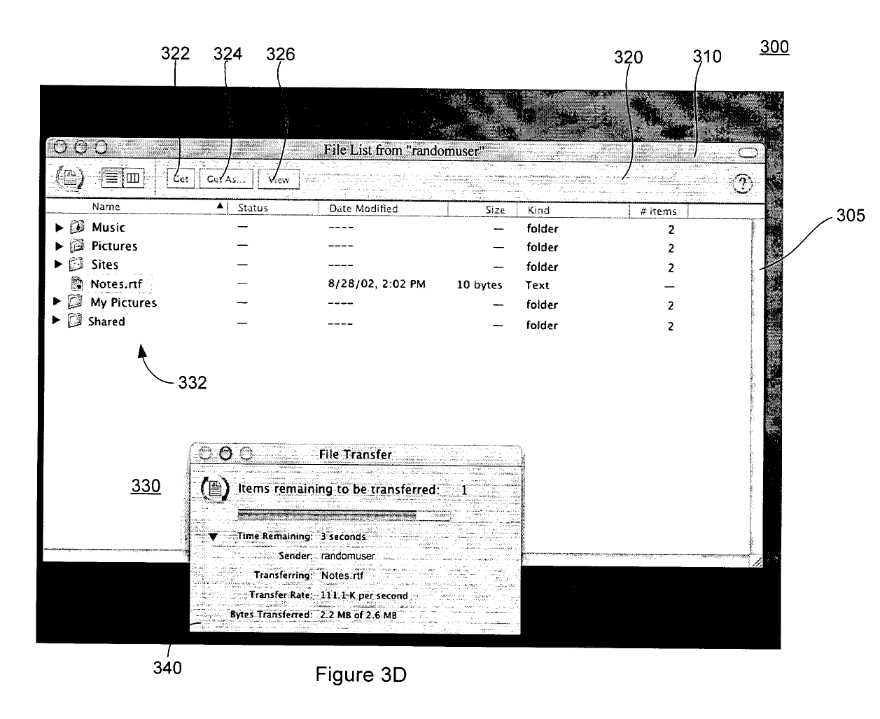

FIGS. 3A-3D illustrate exemplary aspects of an interface 305 that allow the program user to access a contact's shared files or folders. In addition to communicating with the IM program on the contact's client system to obtain permission and a list of shared files or folders, the user's IM program may invoke interface 305 to allow the user to access the shared files or folders. Through interface 305, the user can navigate through the shared files and folders and download any of the shared files or folders to the user's client system, if desired. While the exemplary interface 305 provides access to view files or folders, copy files or folders from one system to the other, and to open or execute a file or folder, other implementations of the interface and IM programs may support access for other operations related to the shared items (e.g., being able to write to a file or folder, modify a file or folder, or to print a file). The IM programs communicate as needed to accomplish the operation for which access is provided.

FIG. 3A illustrates an aspect of the interface 305 that may be invoked when the user first initiates access to the contact's shared files or folders. Shown is a computer desktop 300 with interface 305. The interface includes a title bar 310 that indicates the contact whose shared files or folders are being accessed (in the example shown, the shared files or folders of the contact “randomuser” are being accessed).

Interface 305 also includes a toolbar area 320 and a client area 330. Once a list of the shared files or folders is obtained, the shared files or folders are listed in client area 330. Toolbar area 320 includes buttons for performing operations related to the shared files or folders. A “Get” button 322 is used to download a shared file or folder that is selected in client area 330. The Get button results in a download of the file or folder to a default location and with a name that is the same as the one displayed in client area 330. A “Get As” button 324 also is used to download a shared file or folder that is selected in client area 330. Get As button 324 results in invocation of a “Save As” dialog box that allows the user to choose a download location different than the default location and/or change the name of the downloaded file or folder. A “View” button 326 downloads a selected file to a temporary directory and either opens or executes the file, depending on whether the file is a data file or an executable file. For instance, if a selected file is a text file, the View button 326 may be used to download the file to a temporary directory and open the file using a text editor or viewer.

Other ways of performing the operations related to the shared items may exist as an alternative, or in addition, to the buttons on toolbar area 320. For example, an operation may be invoked by selecting the operation from a menu, such as a context menu.

When the user initiates access to the contact's shared files or folders, the user's IM program may or may not communicate with the contact's IM program to determine if the user is permitted to access the shared files or folder. Access permissions may be excluded in some implementations. While permission to access the shared files or folders is being obtained, text 328 may be displayed in toolbar area 320 to provide a visual indication of the process undertaken by the IM program or the reasons for any perceived delay. For example, as shown, text 340 may indicate to the user that permission is being obtained. If permission is obtained, a list of the shared files or folders is transmitted to and received by the user's IM program and the user's IM program reads the received list of shared files or folders and populates client area 330 with the names, and possibly other information, of the shared files or folders. The text 328 also is removed once the list is received.

FIG. 3B illustrates the interface 305 after an exemplary list of shared files or folders has been obtained. The exemplary list of shared items includes five folders and one file. A list 332 of the shared files or folders is provided in client area 330. For each file or folder, the list 332 indicates various information, such as the file's or folder's name, status, date modified information, size, type (i.e., file or folder), and, if the item is a folder, how many items the folder contains.

A folder may contain more shared files or folders and may be opened, for example, by selecting an arrow to the left of the folder's name. Opening a folder results in display of a list of files or folders contained in the open folder under, for example, the name of the opened folder.

FIGS. 3C and 3D illustrate exemplary aspects of the interface 305 that are displayed when the user downloads one of the shared files or folders. The user may download one of the shared items by selecting the item in the list 332 and then selecting the Get button 322. Referring to FIG. 3C, the user has selected the file “Notes.rtf” and then used the Get button 322 to initiate a download of the selected file. In response, the user's IM program sends an identifier of the selected file, such as the name of the file, to the contact's IM program. The contact's IM program then retrieves the file and transmits a copy to the user's IM program, which saves the copy in the file system of the user's client system. The communications and the transfer of the file may be performed directly between the IM programs, or may be performed through a host system. The contact's IM program alternatively may arrange for the file to be transferred to the user through another communications mechanism, such as e-mail, instead of directly to the user's IM program.

Referring to FIG. 3D, once the download is started, the user's instant messaging program may display a file transfer dialog box to reflect download status while the file is being transferred. File transfer dialog box 340 exemplifies such a dialog box, showing the current status of the file transfer. As shown, the dialog box 340 displays the time remaining for the download (3 seconds), the sender (randomuser), the name of the file being transferred (Notes.rtf), the transfer rate (111.1 K/s), and the number of bytes already transferred (2.2 MB of 2.6 MB). Once the download is completed, feedback (e.g., a sound) may be provided to the user to indicate the transfer is complete, and file status dialog 340 may be closed.

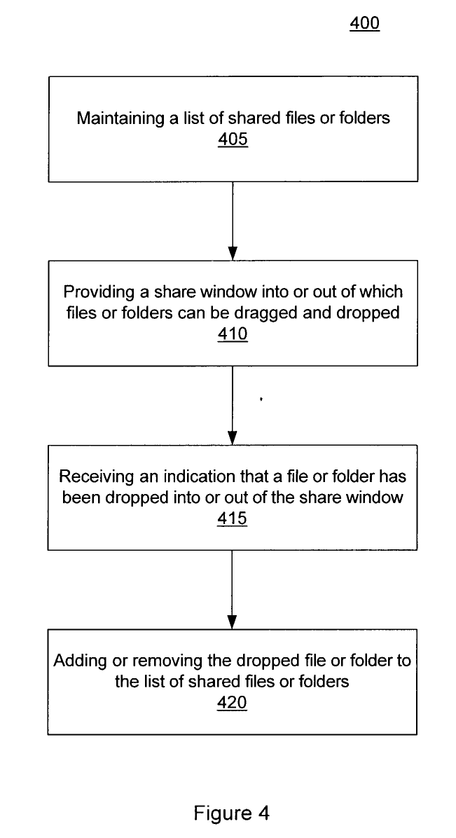

FIG. 4 illustrates a method 400 for assisting a user of a communications program (such as the IM program described with respect to FIGS. 3A-3D) executing on a first client system in sharing files or folders across a network with a user of a communications program executing on a second client system. The communications program on the first client system maintains a list of shared files or folders that are accessible using the communications program executing on the second client system (405). The shared files or folders are accessible regardless of whether the users are actively communicating using the communications programs. The communications program on the first client system also provides a share window into which the user can drag and drop files or folders without changing the location of the files or folders (410). When the user drops a file or folder into the share window, the communications program receives an indication that the file or folder has been dropped (415). The communications program adds the dropped file or folder to the list of shared files or folders in response to receiving the indication that the dropped file or folder has been dropped into the share window (420).

The shared files or folders may be located in the file system of the first client system, or (when network 104 is the Internet, for example) the shared files may be located remotely (e.g., on a server system such as host server 106). The shared files also may be located on a system in a local area network (LAN) of which the first client system is a part.

The list of shared files or folders may be maintained locally on the first client system, or it may be maintained remotely, such as, for example, on a server system such as host server 106. If the list is maintained remotely, the IM program executing on the first client system may communicate the entire list to the server system each time the list changes, or may only communicate incremental updates of the list to the server system.

As described above, after the user of the communications program on the second client system initiates access to the shared files or folders, the communications program on the first client system transmits a list of the shared files or folders to the communications program on the second client system. The list of shared files or folders that is transmitted to the communications program executing on the second client system may be the same as the list maintained by the communications program on the first client system, or the transmitted list may be generated from the maintained list. For instance, in the example above, the IM program receives and displays basic information about the shared files or folders such as name, status, modification date information, size, kind (i.e., file or folder), and how many items each folder contains. The list of shared files or folders maintained by the communications program on the first client system may contain all of this information and be transmitted. Alternatively, the maintained list may contain additional or alternative information and be transmitted, with only the basic information being displayed by the receiving IM program. As another alternative, the maintained list may contain an identifier of each shared file or folder, such as the fully qualified path name, which is used to retrieve the other information from the file system to generate the transmitted list.

Another example of an implementation in which the transmitted list is generated from the maintained list comprises having the communications program store only the top-level shared items. The top-level shared items then are used to generate the transmitted list. To generate the transmitted list, the top-level shared items may be iterated and the directory trees recursively walked to obtain the lower-level shared items (i.e., items contained in a top-level folder) and file/folder information for the shared items. This file/folder information then is placed in the list to be transmitted, along with the top-level shared item information.

In some implementations, the communications program may store the list of files or folders using alias records. An alias record is a data structure that identifies a file, folder, or volume. In this case, whenever the communications program adds a folder or file to the shared items, the communications program records the location and other identifying information of the file or folder in an alias record. When the communications program later needs access to the file or folder, the communications program uses an alias manager to locate the file or folder, even if the user has renamed it, copied it, restored it from backup, or moved it. One environment in which such alias records may be used is a Mac OS X environment.

A new list of shared items may be transmitted to users who currently are accessing the shared files when a new file or folder is added. Alternatively, the new list may be transmitted only when such users request access to the shared items again.

The share window may be provided as an integral part of the interface for the communications program, or it may be provided as a separate window. The share window may be a window of the communications program or the share window may be a window of a separate program that cooperates with the communications program to perform the techniques described. The share window may contain representations of some or all of the files and folders currently being shared (i.e., representations of some or all of the files or folders on the list of shared files or folders may be added to the share window).

When the window contains representations and the list of shared files or folders persists between sessions of the communications program, the window may contain representations of files or folders added to the list in past sessions along with those added in the current session. Thus, in this case, if one uses the window to share some items, quits the communications program, executes the communications program and invokes the window, all of the previously shared items are still represented in the window. Alternatively, however, the window may only contain representations of shared files or folders added in the current session or some other subset of the shared files or folders.

When representations are provided in the share window, drag and drop removal of files or folders from the shared files or folders also may be supported. In this case, the user can drag and drop the representations of the files or folders out of the share window without changing the location of the file or folder in the file system of the first client system (410). When the user drags and drops a representation out of the share window, the communications program receives an indication that the representation has been dropped (415). The communications program removes the file or folder corresponding to the dropped representation from the list of shared files or folders in response to receiving the indication of the drop (420). The communications program also removes the representation from the share window.

While method 400 illustrates the support of both removal and addition of files or folders to the shared files or folders by dragging and dropping into and out of the share window, removal and addition may be implemented separately. That is, addition of files or folders by drag and drop may be supported without supporting removal by drag and drop, or removal of files or folders by drag and drop may be supported without supporting addition by drag and drop.

The share window may be provided with controls for performing operations on or related to the shared files or folders. For instance, an add button may be provided on the share window for adding files or folders by browsing the file system and selecting a file or folder, rather than by dragging and dropping the file or folder. A remove button, for example, may be provided on the share window for removing files or folders by selecting the file's or folder's representation and then selecting the remove button, rather than by dragging and dropping the representation. In another example, a reveal button may be provided on the share window for showing the location of the shared files or folders in the file system of the client system.

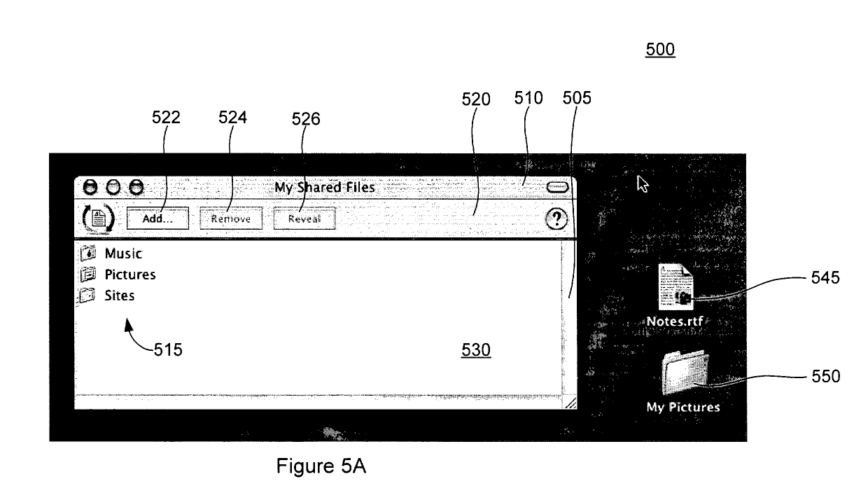

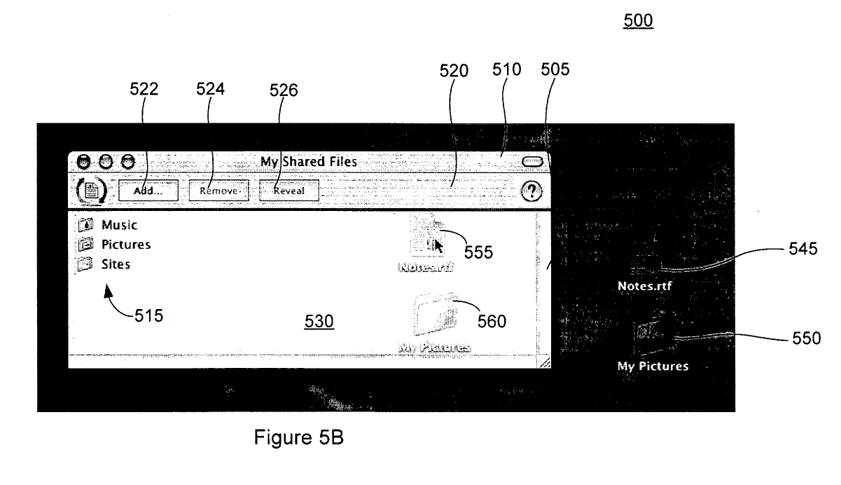

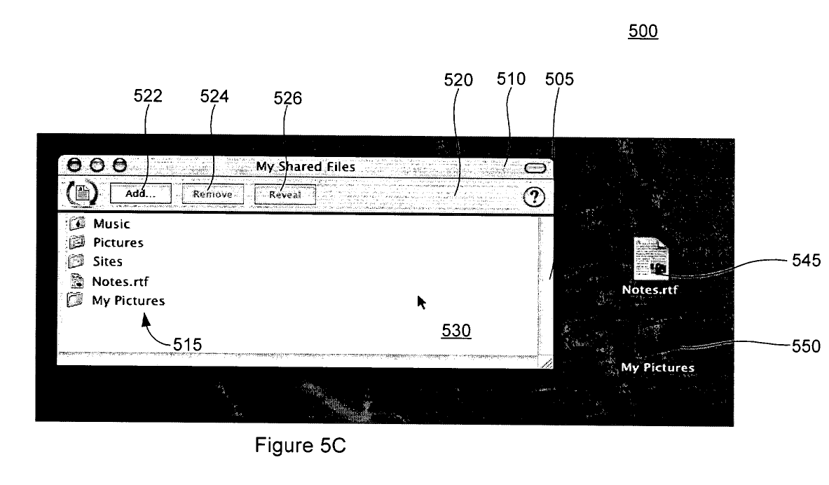

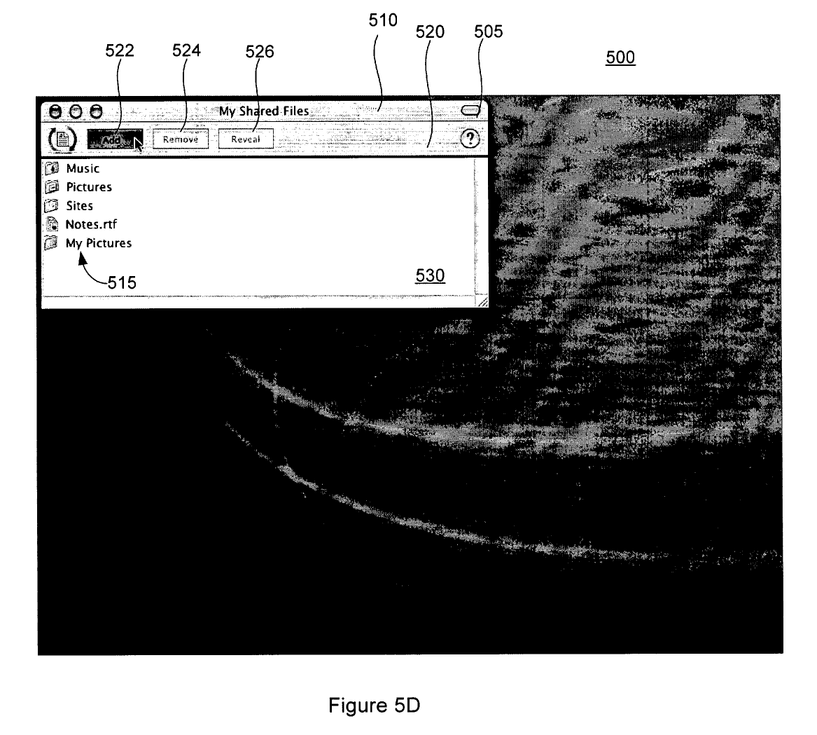

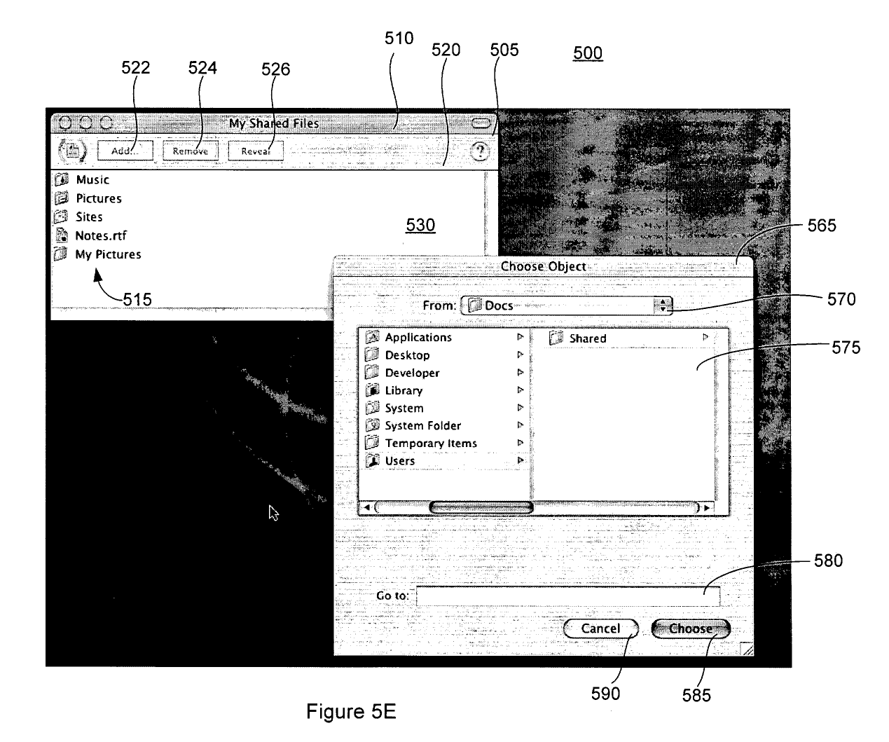

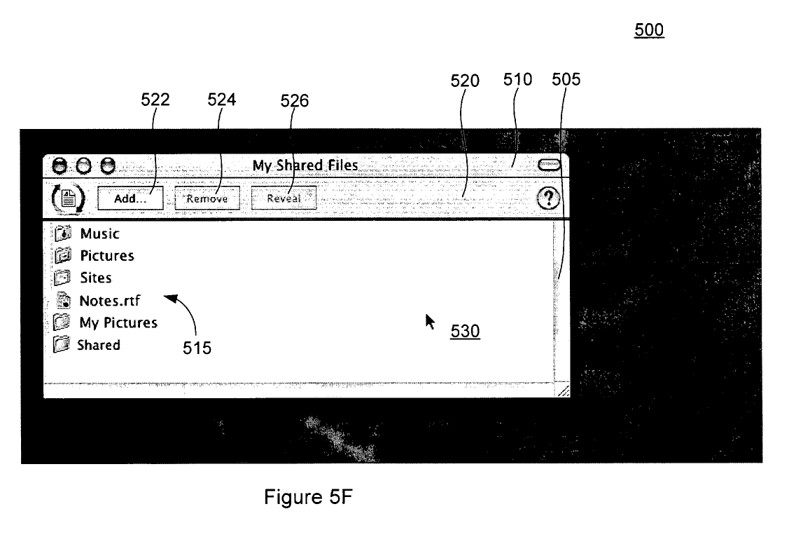

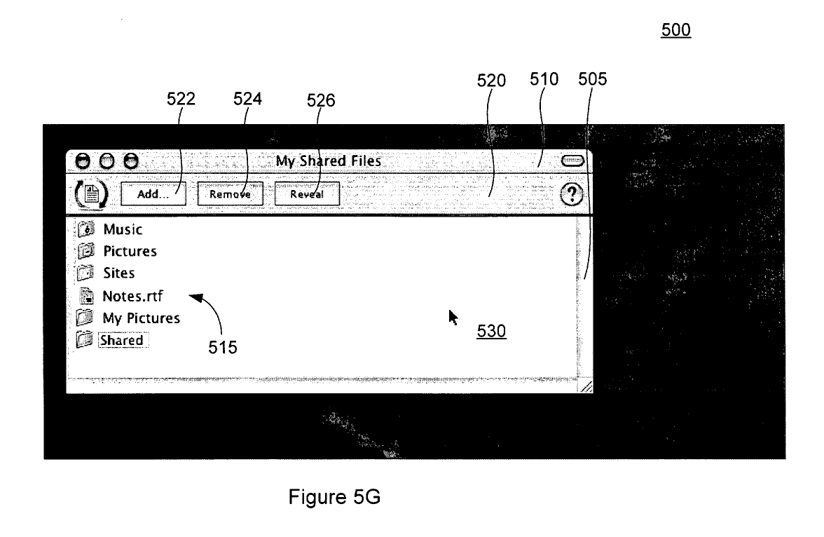

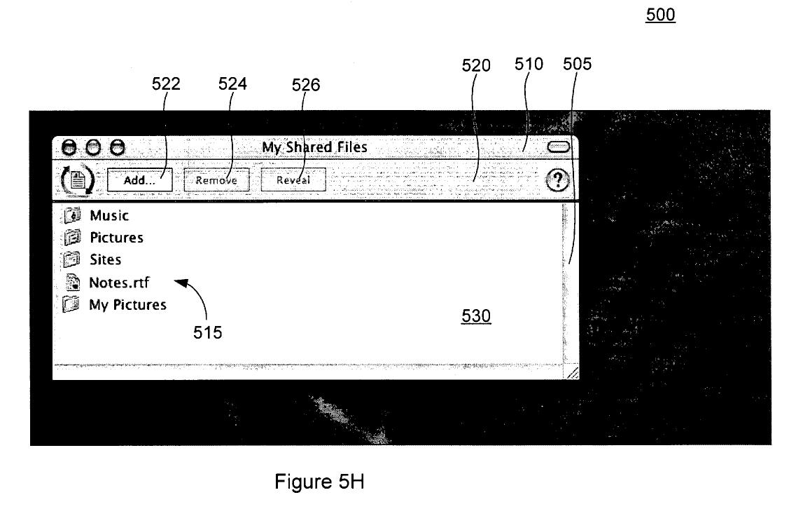

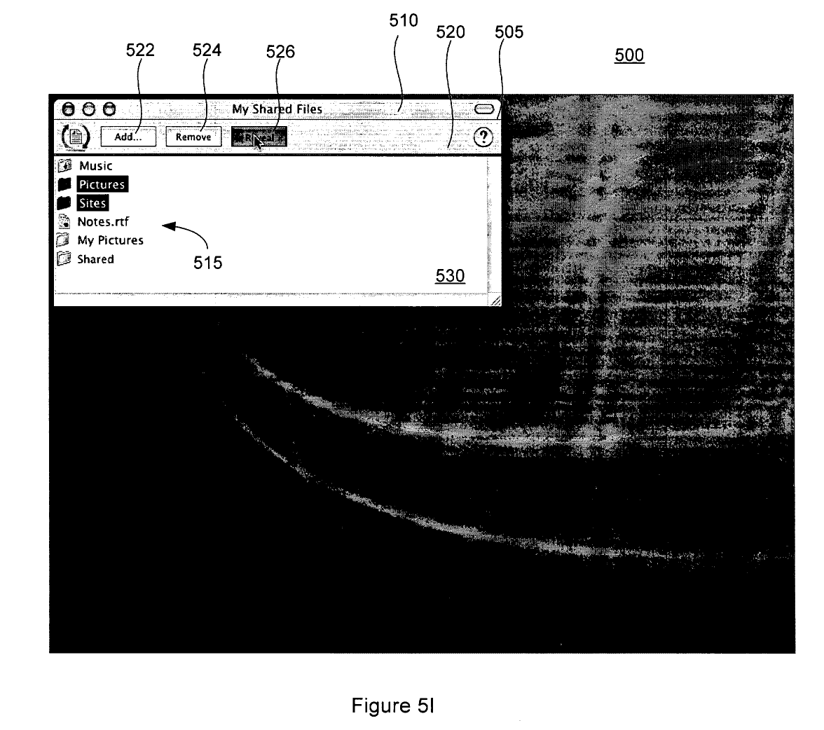

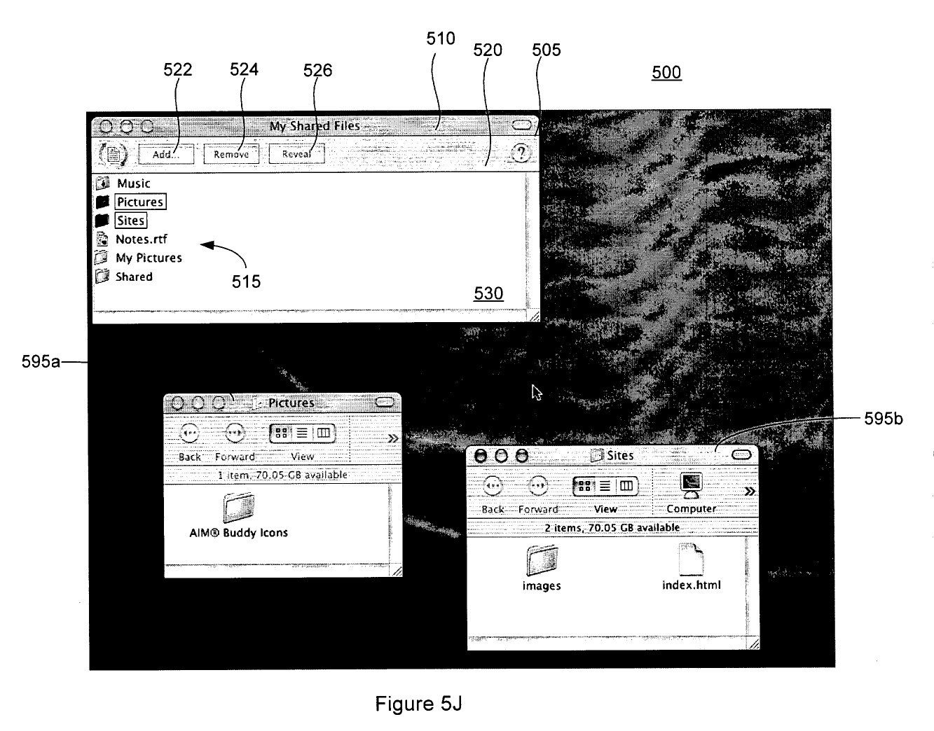

FIGS. 5A-5J illustrate the operation of implementations of the above techniques. Shown is a desktop 500 with an exemplary share window 505. Share window 505 includes a title bar 510, a toolbar area 520, and a client area 530. Title bar 510 displays the title of share window 505 (e.g., “My Shared Files”).

Files or folders can be dragged and dropped into client area 530 to cause their addition to the shared items. When a file or folder is dropped into client area 530, the communications program adds the dropped file or folder to the list of shared files or folders without performing a move (or equivalent) operation on the dropped file or folder. Thus, the dropped file or folder is added to the shared items without changing the location of the dropped file or folder in the file system. Further, representations 515 of the currently shared items may be displayed in the client area 530. In the example illustrated, the shared items are represented by an icon and the shared item's name. Also in the example illustrated, the currently shared items include three folders: a “Music” folder, a “Pictures” folder, and a “Sites” folder.

Toolbar area 520 includes an add button 522, a remove button 524, and a reveal button 526. Add button 522 allows files or folders to be added to the shared files or folders by browsing the file system and selecting the file or folder, rather than by dragging and dropping. Remove button 524 allows for a file or folder to be removed from the shared files or folders by selecting the file's or folder's representation and then selecting the remove button, rather than by dragging and dropping the representation. Reveal button 526 allows the location of the shared files or folders in the file system to be viewed by selecting the file's or folder's representation and then selecting reveal button 526. As shown, when no representations have been selected, remove button 524 and reveal button 526 may be “grayed out” (i.e., inactive). FIGS. 5B and 5C illustrate the addition of a file and a folder to the shared items by dragging and dropping the file and folder into share window 505. A file 545 is located on desktop 500. Also located on desktop 500 is a folder 550 that may or may not contain other files or folders. To share file 545 and/or folder 550, the user may drag and drop file 545 and/or folder 550 into client area 530. To drag file 545 and/or folder 550 into client area 530, the user first selects file 545 and/or folder 550, for example, by pointing at them and pressing a mouse button. Holding the mouse button, the user then drags the selected file 545 and/or folder 550 towards client area 530. As the user drags file 545 and/or folder 550 across desktop 500, transparent images 555 and 560 show the user where file 545 and/or folder 560 are being dragged, respectively. Once the transparent images 555 and 560 are in client area 530, the user drops the transparent images 555 and 560, for example, by releasing the mouse button.

When the user drops transparent images 555 and 560, the communications program receives an indication that they have been dropped onto client area 530. The indication includes information, such as the fully qualified path name, that designates the file and folder that were dropped. Upon receiving the indication, the communications program adds file 545 and folder 550 to the list of shared files or folders. Referring to FIG. 5C, the locations of file 545 and folder 550, however, are not changed. Representations of file 545 and folder 550 may be added to representations 515 in client area 530.

FIGS. 5D-5F illustrate the use of the add button 522 to add a folder to the shared items. Referring to FIG. 5D, to use add button 522 to add a file or folder, the user first selects add button 522 by pointing to it using a mouse and clicking a mouse button. Referring to FIG. 5E, when the user selects add button 522, a choose object dialog box 565 is invoked. In general, dialog box 565 allows a user to navigate through the file system and select a file or folder to be added to the shared files or folders.

The illustrated dialog box 565 allows a user to navigate and browse the file system using a column browser 575. Once the user has found the item he or she wants shared, the user can select the name of the file or folder in column browser 575, and then select a choose button 585 to have the file or folder added to the shared files or folders. Dialog box 565 has a pop-up menu 570 that contains some of the most recent folders to which the user has opened or saved documents. With pop-up menu 570, the user can go immediately to a folder that has recently been used. Dialog box 565 also has a “Go To” text field 580 in which a user can type file-system paths to navigate the file system. A cancel button 590 is provided to cancel the add operation.

FIG. 5F illustrates the result of the user navigating to and selecting the “Shared” folder using dialog box 565. When the user selects a file or folder in column browser 575 and then selects choose button 585, the communications program receives an indication of the file or folder selected. The communications program then adds the file or folder to the list of shared files or folders and may add a representation of the added file or folder to client area 530. The file's or folder's position in the file system is not affected. As shown in FIG. 5F, a representation of the Shared folder has been added to the representations 515 in client area 530.

FIGS. 5G and 5H illustrate the use of remove button 524 to remove a folder from the shared items. Referring to FIG. 5G to use remove button 525 to remove a file or folder, the user first selects a representation of the file or folder from the representations 515 in client area 530. For example, the user may select a representation by pointing to it using a mouse and clicking a mouse button. In the example shown, the user has selected the representation of the Shared folder. Once the user selects one or more files or folders, the user then selects remove button 524 by pointing to it and clicking a mouse button, for example.

FIG. 5H illustrates the result of the user selecting the representation of the Shared folder and then selecting the remove button 524. When the user clicks the remove button 524, the communications program receives an indication of the selected representation. The communications program then removes the selected representation from client area 530 and removes the corresponding file or folder from the list of shared files or folders. The file's or folder's position in the file system is not affected. As shown in FIG. 5H, the representation of the Shared folder has been removed from the representations 515 in client area 530.

FIGS. 5I and 5J illustrate the use of reveal button 526 to show a shared file's or folder's location in the file system. To use reveal button 526 to show the location of a shared file or folder, the user first selects a representation of the file or folder from the representations 515 in client area 530. For example, the user may select a representation, for example, by pointing to it using a mouse and clicking a mouse button. Once the user selects one or more files or folders, the user then selects reveal button 526 by pointing to it and clicking a mouse button, for example.

When the user selects reveal button 526, a file system browser window is opened for each selected file. Although other implementations and examples are contemplated, two examples of a file browser window are the Finder window of a Macintosh OS X environment and the Windows Explorer window of a Microsoft Windows® environment. In general, a file system browser window allows the user to browse the file system. Each file system browser window opened by reveal button 526 is opened to the corresponding shared file's or folder's location in the file system.

Referring to FIG. 5I, the user has selected the representations of the Pictures folder and the Sites folder in the example shown. Referring to FIG. 5J, after the user selects the reveal button 526, first and second file system browser windows 595a and 595b are opened. The first file system browser window 595a has been opened to the location of the Pictures folder and shows the contents of the Pictures folder, which contains a folder, “AIM® Buddy Icons.” The second file system browser window 595b has been opened to the location of the Sites folder and shows the contents of the Sites folder, which contains a folder “images” and a file “index.html.” Other ways of showing a file's or folder's location are possible. For example, a window with a tree directory showing the file's or folder's overall location in the file system may be provided.

Implementations of the foregoing techniques also may allow a user to designate that a shared file or folder is shared with all of the user's contacts, with a subset of the user's contacts, with only a single contact, or with some combination thereof. For example, many IM programs permit a user to group the contacts into groups such as, for example, co-workers, friends, and classmates. An implementation for such an IM program may allow the user to designate certain files or folders as being shared with only one or more of the groups. Implementations may provide a user with the ability to define more complex rules (such as through a scripting language) with regard to which contacts may access the shared files or folders. In addition, the share window may be modified to indicate with whom the files or folders are shared.

While the various interface components shown in the drawings may resemble Macintosh interface components, this is not meant to be limiting. For example, while the dialog window illustrated in FIG. 5E resembles a Mac OS X open dialog window, the dialog window may have characteristics of other types of dialog windows, such as those for a Microsoft Windows® open dialog box. It will be understood that, in general, the various interface components will have characteristics that are somewhat dependent on the operating environment in which the present techniques are implemented.

The techniques described above are not limited to any particular hardware or software configuration. Rather, they may be implemented using hardware, software, or a combination of both. The methods and processes described may be implemented as computer programs that are executed on device comprising at least one processor and at least one data storage system (e.g., programmable computer, cellular phone, or personal digital assistant.). The data storage system may be any type of storage medium or device usable with a processor (e.g., CD-ROM, RAM, or magnetic disk). The programs may be implemented in a high-level programming language and may also be implemented in assembly or other lower level languages, if desired.

Any such program will typically be stored on a computer-usable storage medium or device (e.g., CD-ROM, RAM, or magnetic disk). When read into the processor of the computer and executed, the instructions of the program cause the programmable computer to carry out the various operations described.

Other implementations are also within the scope of the following claims.

What is claimed is:

1. A method of enabling a first user of a first communications program executing on a first client system to share files or folders across a network with a second user of a second communications program executing on a second client system, the method comprising:
maintaining a list of shared files or folders that are accessible using the second communications program, the shared files or folders being accessible regardless of whether the first user and second user are actively communicating using the first and second communications programs;
providing a share window with which the first user can designate files or folders to be included on the list without changing the location of the files or folders; and
adding a file or folder to the list of shared files or folders when the first user designates the file or folder listing with the share window.

2. The method of claim 1 further comprising adding a representation of the designated file or folder to the share window to indicate that the designated file or folder is a shared file or folder.

3. The method of claim 1 wherein the shared files or folders are located in a file system of the first client system.

4. The method of claim 1 wherein the shared files or folders are located in a file system accessible to the first client system.

5. The method of claim 1 wherein the first communications program comprises an instant messaging program.

6. A method of enabling a first user of a first communications program executing on a first client system to share files or folders across a network with a second user of a second communications program executing on a second client system, the method comprising:
maintaining a list of shared files or folders that are accessible using the second communications program, the shared files or folders being accessible regardless of whether the first user and second user are actively communicating using the first and second communications programs;
providing a share window into which the first user can drag and drop files or folders without changing the location of the files or folders; and
adding a file or folder to the list of shared files or folders in response to the first user dropping the file or folder into the share window.

7. The method of claim 6 further comprising adding a representation of the dropped file or folder to the share window to indicate that the dropped file or folder is a shared file or folder.

8. The method of claim 7 further comprising:
receiving an indication that the representation of a shared file or folder has been dragged and dropped out of the share window; and
in response to receiving the indication that the representation has been dragged and dropped out of the share window, removing the dropped file or folder corresponding to the representation from the list of shared files or folders.

9. The method of claim 6 further comprising:
providing an add button as part of the share window;
receiving an indication that the first user has selected the add button;
invoking an open dialog box in response to receiving the indication that the first user has selected the add button;
receiving an indication of a selected file or folder from the open dialog box; and
adding the selected file or folder to the list of shared files or folders in response to receiving the indication of the selected file or folder from the open dialog box.

10. The method of claim 9 further comprising adding a representation of the selected file or folder to the share window to indicate that the selected file or folder is a shared file or folder.

11. The method of claim 6 further comprising:
providing a representation of at least one of the files or folders on the list of shared files or folders in the share window;
providing a remove button as part of the share window;
receiving an indication that the first user has selected the representation;
receiving an indication that the first user has selected the remove button; and
removing the file or folder that corresponds to the selected representation from the list of shared files or folders in response to receiving the indication that the first user has selected the remove button.

12. The method of claim 6 further comprising:
providing a representation of at least one of the files or folders on the list of shared files or folders in the share window;
providing a reveal button as part of the share window;
receiving an indication that the first user has selected the representation;
receiving an indication that the first user has selected the reveal button; and
invoking a file system browser window that shows the location of the file or folder that corresponds to the selected representation in the file system of the first client system.

13. The method of claim 6 wherein the shared files or folders are located in a file system of the first client system.

14. The method of claim 6 wherein the first communications program comprises an instant messaging program.

15. A user interface for enabling a first user of a first communications program executing on the first client system to share files or folders across a network with a second user of a second communications program executing on a second client system, the user interface comprising:
a share window into which the first user can drag and drop files or folders without changing the location of the files or folders in the file system of the first client system;
wherein, in response to the first user dropping a file or folder into the share window, the dropped file or folder is added to a list of shared files or folders that are accessible using the second communications program, the shared files or folders being accessible regardless of whether the first user and second user are actively communicating using the first and second communications programs.

16. The interface of claim 15 wherein a representation of the designated file or folder is added to the share window to indicate that the designated file or folder is a shared file or folder.

17. The interface of claim 15 wherein the shared files or folders are located in a file system of the first client system.

18. The interface of claim 15 wherein the shared files or folders are located in a file system accessible to the first client system.

19. The interface of claim 15 wherein the first communications program comprises an instant messaging program.

20. A computer-usable medium having a computer program embodied thereon for enabling a first user of a first communications program executing on a first client system to share files or folders across a network with a second user of a second communications program executing on a second client system, the computer program comprising instructions for causing a computer to:
maintain a list of shared files or folders that are accessible using the second communications program, the shared files or folders being accessible regardless of whether the first user and second user are actively communicating using the first and second communications programs;
provide a share window into which the first user can drag and drop files or folders without changing the location of the files or folders; and
add a file or folder to the list of shared files or folders in response to the first user dropping the file or folder into the share window.

21. The computer-usable medium of claim 20 wherein the computer program further comprises instructions for causing a computer to add a representation of the dropped file or folder to the share window to indicate that the dropped file or folder is a shared file or folder.

22. The computer-usable medium of claim 21 wherein the computer program further comprises instructions for causing a computer to:
receive an indication that the representation has been dragged and dropped out of the share window; and
remove the file or folder corresponding to the representation from the list of shared files or folders in response to receiving the indication that the representation has been dragged and dropped out of the share window.

23. The computer-usable medium of claim 20 wherein the computer program further comprises instructions for causing a computer to:
provide an add button as part of the share window;
receive an indication that the first user has selected the add button;
invoke an open dialog box in response to receiving the indication that the first user has selected the add button;
receive an indication of a selected file or folder from the open dialog box; and
add the selected file or folder to the list of shared files or folders in response to receiving the indication of the selected file or folder from the open dialog box.

24. The computer-usable medium of claim 23 wherein the computer program further comprises instructions for causing a computer to add a representation of the selected file or folder to the share window to indicate that the selected file or folder is a shared file or folder.

25. The computer-usable medium of claim 20 wherein the computer program further comprises instructions for causing a computer to:
provide a representation of at least one of the files or folders on the list of shared files or folders in the share window;
provide a remove button as part of the share window;
receive an indication that the first user has selected the representation;
receive an indication that the first user has selected the remove button; and
remove the file or folder that corresponds to the selected representation from the list of shared files or folders in response to receiving the indication that the first user has selected the remove button.

26. The computer-usable medium of claim 20 wherein the computer program further comprises instructions for causing a computer to:
provide a representation of at least one of the files or folders on the list of shared files or folders in the share window;
provide a reveal button as part of the share window;
receive an indication that the first user has selected the representation;
receive an indication that the first user has selected the reveal button; and
invoke an file system browser window that shows the location in the file system of the first client system of the file or folder that corresponds to the selected representation.

27. The computer-usable medium of claim 20 wherein the shared files or folders are located in a file system of the first client system.

28. The computer-usable medium of claim 20 wherein the first communications program comprises an instant messaging program.
